(19) United States
(12) Patent Application Publication
(10) Pub. No.: US 2022/0041048 A1
(43) Pub. Date: Feb. 10, 2022

(54) A HEATING VENTILATION AND AIR CONDITIONING SYSTEM

(71) Applicant: Valeo Systemes Thermiques, Le Mesnil Saint Denis Cedex (FR)

(72) Inventors: Radoslaw Godzina, Skawina (PL); Lukasz Barus, Skawina (PL); Tomasz Wator, Skawina (PL); Krysztof Brankiewicz, Skawina (PL)

(73) Assignee: Valeo Systemes Thermiques, Le Mesnil Saint Denis Cedex (FR)

(21) Appl. No.: 17/416,865

(22) PCT Filed: Dec. 20, 2019
(86) PCT No.: PCT/EP2019/086719

§ 371 Date: Jun. 21, 2021

(30) Foreign Application Priority Data
Dec. 21, 2018 (EP) 18461655.5

(51) Int. Cl. B60K 11/08; B60K 11/06

(52) U.S. Cl. CPC B60K 11/08; B60K 11/06

(57) ABSTRACT

A protective grid system for ducts of a cooling module of a vehicle is disclosed. The system includes housing and at least one protective grid. The housing includes at least one inlet connected to the ducts for receiving air that had extracted heat from a region to be cooled and at least one outlet for egress of the air there through. The at least one protective grid is mounted over at least one of the at least one inlet and the at least one outlet to prevent articles of a predetermined size from entering inside the ducts of the cooling module while still permitting egress of air there through.

The present disclosure relates to a cooling module for a vehicle, particularly, the present disclosure relates to a protective grid system for ducts of the cooling module.

Generally, cooling modules for use in vehicles include at least one air inlet, at least one air outlet and a network of ducts for facilitating fluid communication between the at least one air inlet and the at least one air outlet. At least one fan system directs air received by the at least one air inlet to the at least one air outlet. Generally, the at least one air inlet is configured on front bumper or front fender of the vehicle for receiving the air required for cooling. The air so received by the at least one air inlet is passed through a region to be cooled such as for example, an engine and/or a battery depending upon whether the vehicle is an electric vehicle, an engine powered vehicle and a hybrid vehicle. The air after extracting heat from the region to be cooled traverses through the ducts and is ultimately expelled out of the vehicle through the at least one air outlet. Although, the at least one air inlet and the at least one air outlet are both open to the atmosphere, the at least one air outlet provides a comparatively easier entry to the remnants inside the ducts as the at least one air outlet is of considerable size and is disposed at the vehicle floor that is above the ground from where the remnants can easily enter. Such entry of remnants inside the ducts of the cooling module may cause blockage of the ducts, thereby deteriorating performance of the fan system and the thermal performance of the cooling module. This is a major issue in case of cooling modules for off road and crossover vehicle applications. Accordingly, there is a need for a system for preventing such remnants from entering the ducts, particularly through the air outlet of the cooling module without compromising on the thermal performance of the elements of the cooling module.

An object of the present invention is to provide a protective grid system that eliminates chances of blocking of ducts of an air cooling module due to entry and stacking of remnants such as leafs, twiggles, polythene bags, pebbles, etc. inside the cooling module.

Another object of the present invention is to provide protective grid system that prevents any remnants from entering ducts of a cooling module of a vehicle without compromising on thermal performance of elements of the cooling module.

Yet another object of the present invention is to provide a protective grid system that is simple in construction but also robust in construction.

Still another object of the present invention is to provide protective grid system that can be easily retrofitted on currently used cooling modules without requiring many modifications.

Yet another of the present invention is to provide protective grid system that enhances service life, energy efficiency, thermal performance and reliability of the elements of the cooling module.

In the present description, some elements or parameters may be indexed, such as a first element and a second element. In this case, unless stated otherwise, this indexation is only meant to differentiate and name elements which are similar but not identical. No idea of priority should be inferred from such indexation, as these terms may be switched without betraying the invention. Additionally, this indexation does not imply any order in mounting or use of the elements of the invention.

A protective grid system, hereinafter referred to as “system” for ducts of a cooling module of a vehicle is disclosed in accordance with an embodiment of the present disclosure. The system includes housing and at least one protective grid. The housing includes at least one inlet connected to the ducts for receiving air that had extracted heat from a region to be cooled and at least one outlet for egress of the air there through. The at least one protective grid is mounted over the at least one outlet to prevent articles of a predetermined size from entering inside the ducts of the cooling module while still permitting egress of air there through.

In accordance with an embodiment of the invention, the housing is configured with a fan system for directing air from the at least one inlet to the at least one outlet configured close to said fan system.

In accordance with another embodiment of the invention, the protective grid includes an array of elements that define restricted air passages.

In accordance with an embodiment of the invention, the elements are horizontally and vertically disposed beams that cross each other to configure the restricted air passages.

Generally, the beams are so configured and inclined that the beams prevent entry of articles of the pre-determined size inside the ducts of the cooling module from outside the vehicle.

Alternatively, the elements are honeycomb structures that configure the restricted air passages.

Further, the protective grid includes first engagement elements configured thereon that engages with complimentary second engagement elements configured on the at least one outlet for facilitating detachable mounting of the protective grid over the at least one outlet.

Preferably, the engagement elements are at least one of snap fit engagement elements, clips, screws and expansion pins.

In accordance with an embodiment, the protective grid is of metal and is configured by stamping process.

In accordance with another embodiment of the invention, the protective grid is formed of woven wires.

Alternatively, the protective grid is of composite plastic material and is configured by molding process.

Specifically, the protective grid is received in at least one socket configured around the at least one outlet.

Preferably, the region to be cooled is at least one of an engine and a battery depending upon whether the vehicle is an electric vehicle, an engine powered vehicle and a hybrid vehicle.

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

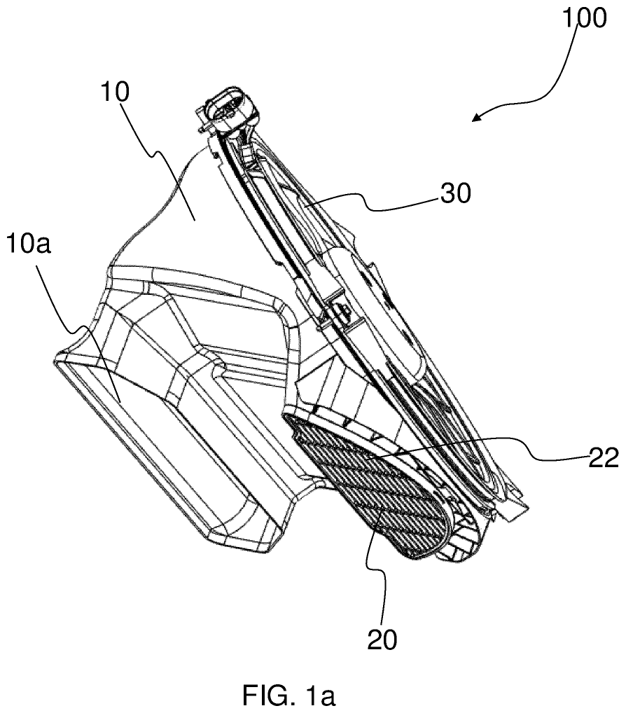

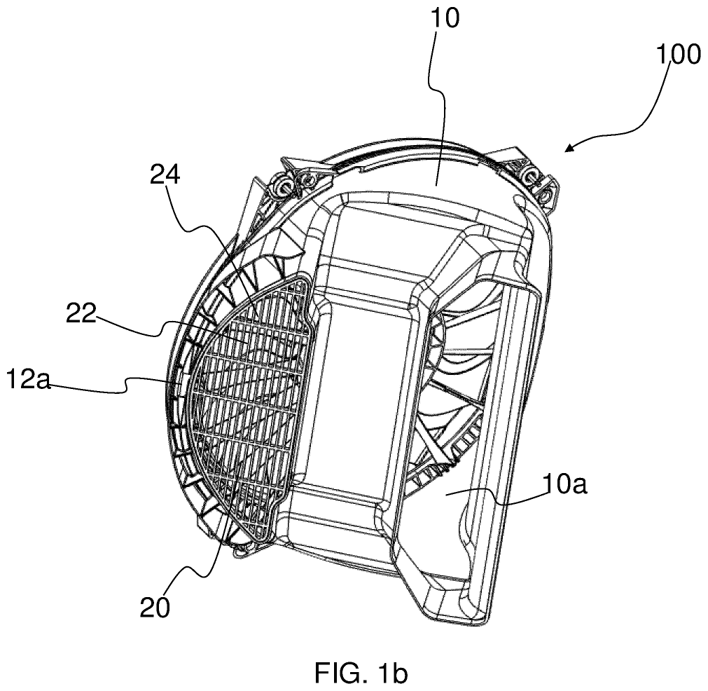

FIG. 1a illustrates an isometric view of a protective grid system in accordance with an embodiment of the present invention, in the FIG. 1a are depicted a housing, an inlet and at least one outlet of the housing and a protective grid mounted over and covering the at least one outlet;

FIG. 1b illustrates another isometric view of the protective grid system of FIG. 1a;

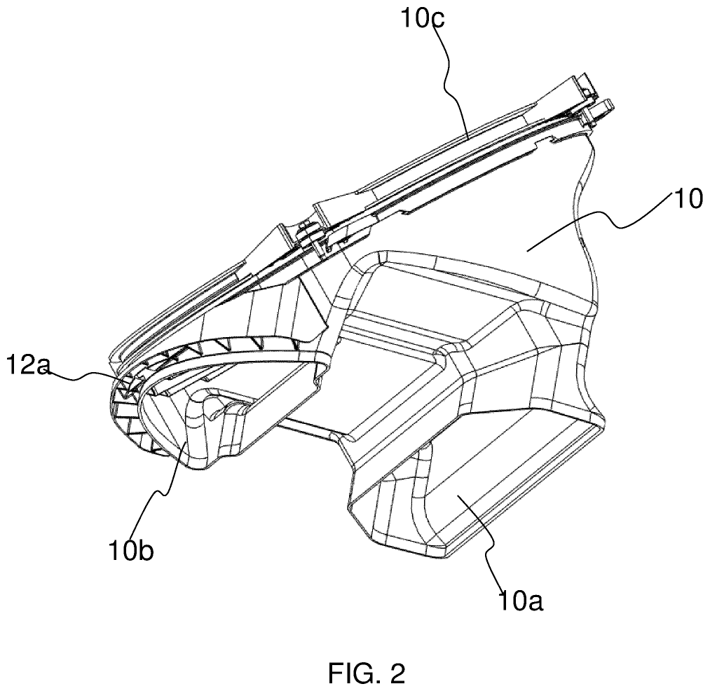

FIG. 2 illustrates an isometric view depicting the protective grid system of FIG. 1a and FIG. 1b without the protective grid covering any of the outlets of the housing;

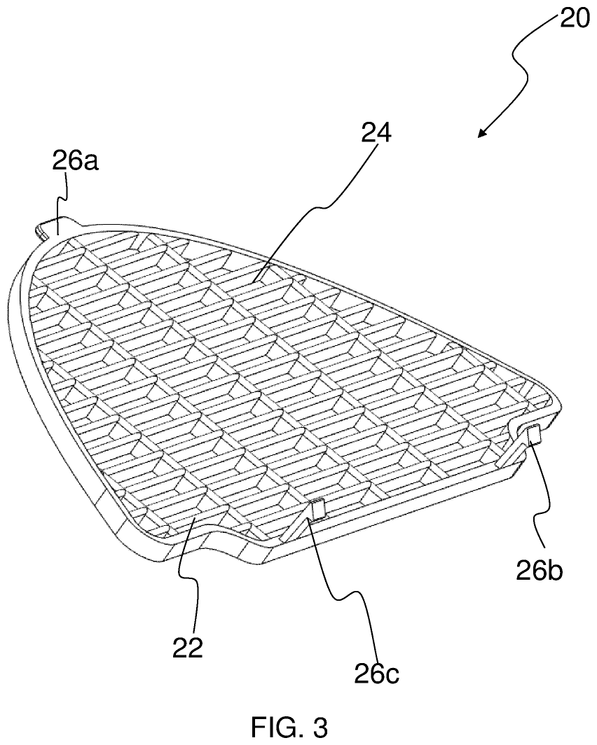

FIG. 3 illustrates an isometric view of the protective grid of FIG. 1a and FIG. 1b with first engagement elements configured thereon;

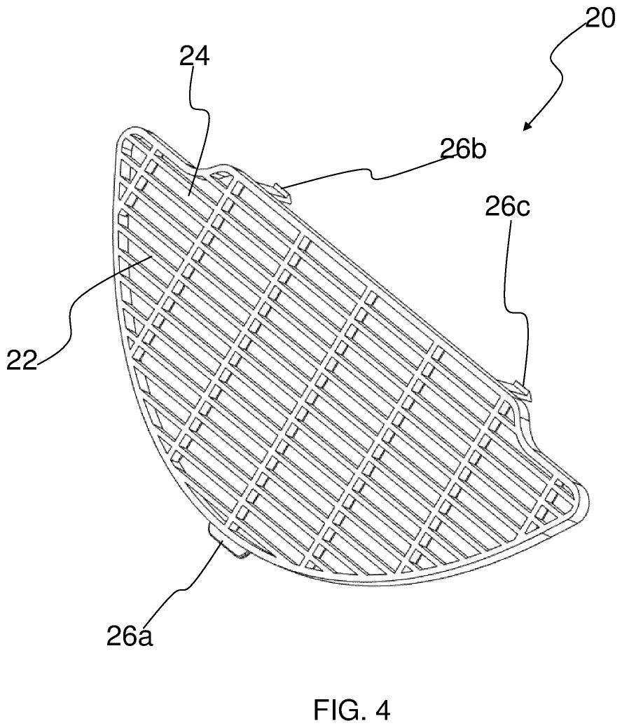

FIG. 4 illustrates another isometric view of the protective grid of FIG. 3; and

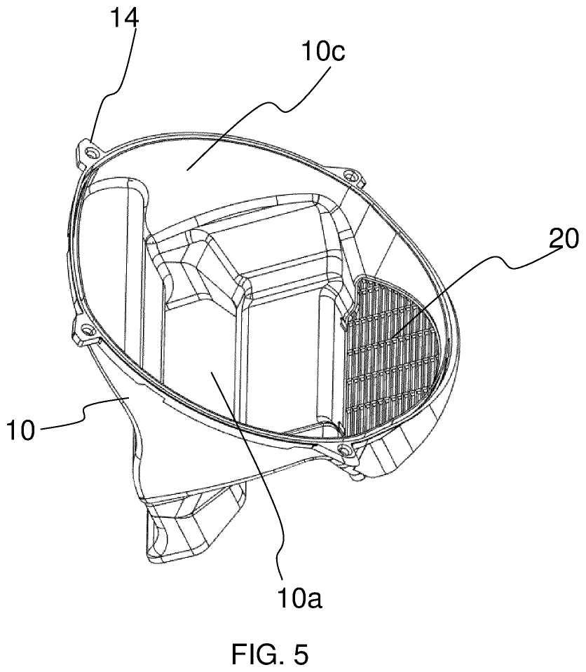

FIG. 5 illustrates an isometric view of the protective grid system of FIG. 1a and FIG. 1b without a fan system.

It must be noted that the figures disclose the invention in a detailed enough way to be implemented, said figures helping to better define the invention if needs be. The invention should however not be limited to the embodiment disclosed in the description.

A protective grid system is disclosed in accordance with an embodiment of the present disclosure. Although, the protective grid system of the present disclosure is mounted on at least one outlet configured on ducts of a cooling module of a vehicle for preventing article of a pre-determined size from entering inside ducts through the at least one outlet, while still allowing air to escape out of the cooling module through the protective grid system, however, the protective grid system of the present invention can be used in any duct system configured in vehicles for restricting entry of articles of pre-determined size from entering inside the modules other than and not limited to cooling module while still permitting escape of the air there through and can also be used in any other applications.

Referring to FIG. 1a-FIG. 1b of the accompanying drawings, an isometric view of a protective grid system 100 in accordance with an embodiment of the present invention is illustrated. In the accompanying drawings and the following description, the protective grid system 100 is explained for use in a cooling module of a vehicle for preventing articles of predetermined size from entering inside the ducts of the cooling module. Also, are depicted elements configuring the protective grid system 100, specifically, a housing 10, an inlet 10c and at least one outlet 10a, 10b of the housing 10 and a protective grid 20 mounted over and covering at least one of the outlet 10a, 10b. The inlet 10c is connected to the ducts for receiving air that had extracted heat from a region to be cooled and the at least one outlet 10a, 10b is configured at the terminal end of the duct directed to the ground for the egress of the air from the cooling module. The region to be cooled is at least one of an engine, a heat exchanger and a battery depending upon whether the vehicle is an electric vehicle, an engine powered vehicle and a hybrid vehicle. However, the region to be cooled could be other than the battery or the engine of the vehicle. The FIG. 1a and FIG. 1b depict the protective grid 20 mounted over and covering the outlet 10b to prevent articles of a predetermined size from entering inside the ducts of the cooling module while still permitting egress of air there through. FIG. 1a and FIG. 1b illustrate isometric views of the protective grid system 100. FIG. 2 illustrates an isometric view depicting the protective grid system 100 without the protective grid 20 covering the any of the outlets 10a, 10b of the housing 10.

Generally, the housing 10 is configured with a fan system 30 for directing air from to the at least one inlet 10c and subsequently the at least one outlet 10a, 10b that are configured close to the fan system 30. Specifically, the at least one inlet 10c is disposed underneath the fan system 30 and receives air that had extracted heat from a region to be cooled whereas the at least one outlet 10a, 10b is disposed downstream of the inlet 10c and the fan system 30 and expels out the air from the cooling module. FIG. 5 illustrates an isometric view of the protective grid system 100 without the fan system 30 for depicting the inlet 10c. The fan system 30 is mounted over the inlet 10c using a mounting arrangement. The mounting arrangement includes complimentary mounting elements 14 that are configured on the housing 10 along the periphery of the inlet 10c and the fan system 30 respectively to facilitate mounting of the fan system 30 over the inlet 10c. More specifically, the mounting arrangement includes holed flanges configured on the housing 10 along the periphery of and inlet 10c the fan system 30. The holes of holed flanges formed on the housing 10 and the fan system 30 are aligned with respect to each other and bolts pass through the aligned holes to facilitate mounting of the fan system 30 over the inlet 10c. The housing 10 is of plastic material, however, the present invention is not limited to any particular configuration of the housing 10, material of the housing 10 and placement of the fan system inside the housing 10.

In accordance with an embodiment, instead of the protective grid 20, multiple protective grids can be used and can be referred as at least one protective grid 20 or simply protective grid 20. The at least one protective grid 20 includes an array of elements 22 that define restricted air passages 24. The elements 22 can be horizontally and vertically disposed beams that cross each other to configure the restricted air passages 24. The elements 22, particularly, the beams are so configured and disposed that the beams prevents any undesirable elements of pre-determined size from entering inside the cooling module, for example, the configuration of the beams is such and the beams are inclined at such an angle that the beams configure enhanced blocking for any article striking the protective grid 20 from outside the vehicle, thereby preventing entry of articles of pre-determined size in the ducts of the cooling module through the protective grid 20, while still permitting air to escape out through the gaps between the adjacent beams of the protective grid 20. Alternatively, the beams can be arranged in any criss-cross manner to configure the restricted air passages 24. Otherwise the elements 22 can be honeycomb structures that configure the restricted air passages 24. The elements are so configured that the protective grid 20 blocks entry of the undesirable remnants without impacting thermal performance and pressure drop across the ducts of the cooling module. In accordance with an embodiment, the protective grid 20 is of metal and is configured by stamping process. Alternatively, the protective grid 20 is formed of woven wires. With such configuration, the protective grid 20 is simple in construction but also robust in construction. However, the present invention is not limited to any particular configuration of the protective grid 20 and array of elements configuring the restricted air passages 24 of the protective grid 20, as far as the protective grid 20 is capable of preventing articles of predetermined size from entering inside the ducts of the cooling module while still allowing the air to pass through the protective grid 20. With such configuration of the system 100 in accordance with an embodiment of the present invention, the protective grid system 100 is capable of preventing article of a pre-determined size from entering inside the ducts of the cooling module of the vehicle from outside the vehicle, while still allowing air to escape out of the cooling module through the protective grid 20 of the system 100. Such configuration of the protective grid system 100 eliminates chances of blocking of the ducts of the air cooling module due to entry of remnants such as leafs, twiggles, polythene bags, pebbles, etc. inside the cooling module.

In accordance with an embodiment of the present invention, the protective grid 20 further includes first engagement elements 26a, 26b, 26c configured thereon that engage with complimentary second engagement elements 12a, 12b, 12c configured on the at least one outlet 10b for facilitating detachable mounting of the protective grid 20 over the at least one outlet 10b. FIG. 3 illustrates an isometric view of the protective grid 20 with the first engagement elements 26a, 26b, 26c configured thereon. FIG. 4 illustrates another isometric view of the protective grid 20 configured with the first engagement elements 26a, 26b, 26c. The engagement elements are at least one of snap fit engagement elements, clips, screws and expansion pins. In accordance with another embodiment of the present invention, the protective grid 20 is received in at least one socket configured around the at least one outlet 10b. However, the present invention is not limited to any particular method of mounting the protective grid 20 over the at least one outlet 10b and configuration of the engagement elements as far as the engagement elements are able to detachably mount the protective grid 20 over the at least one outlet 10b. With such configuration, the protective grid system 100, particularly, the protective grid 20 can be easily retrofitted on currently used cooling modules without requiring many modifications

Several modifications and improvement might be applied by the person skilled in the art to the protective grid system 100 as defined above, as long as it comprises housing and at least one protective grid. The housing includes at least one inlet connected to the ducts for receiving air that had extracted heat from a region to be cooled and at least one outlet for egress of the air there through. The at least one protective grid is mounted over at least one of the at least one inlet and the at least one outlet to prevent articles of a predetermined size from entering inside the ducts of the cooling module while still permitting egress of air there through.

In any case, the invention cannot and should not be limited to the embodiments specifically described in this document, as other embodiments might exist. The invention shall spread to any equivalent means and any technically operating combination of means.

1. A protective grid system for ducts of a cooling module of a vehicle, said protective grid system comprising:
a housing comprising at least one inlet adapted to be connected to the ducts for receiving air that had extracted heat from a region to be cooled and at least one outlet for egress of the air there through; and
at least one protective grid adapted to be mounted over said at least one outlet to prevent articles of a predetermined size from entering inside said ducts of said cooling module while still permitting egress of air there through.

2. The protective grid system as claimed in claim 1, wherein said housing is configured with a fan system for directing air from said at least one inlet to said at least one outlet.

3. The protective grid system as claimed in claim 1, wherein said protective grid comprises an array of elements adapted to define restricted air passages.

4. The protective grid system as claimed in claim 3, wherein said elements are horizontally and vertically disposed beams that cross each other to configure said restricted air passages.

5. The protective grid system as claimed in claim 4, wherein said beams are so configured and inclined that said beams are adapted to prevent entry of articles of the pre-determined size inside said ducts of said cooling module from outside the vehicle.

6. The protective grid system as claimed in claim 3, wherein said elements are honeycomb structures adapted to configure said restricted air passages.

7. The protective grid system as claimed in claim 1, wherein said at least one protective grid further comprises first engagement elements configured thereon and adapted to engage with complimentary second engagement elements configured on said at least one outlet for facilitating detachable mounting of said at least one protective grid over said at least one outlet.

8. The protective grid system as claimed in claim 7, wherein said engagement elements are at least one of snap fit engagement elements, clips, screws and expansion pins.

9. The protective grid system as claimed in claim 1, wherein said at least one protective grid is of metal and is configured by stamping process.

10. The protective grid system as claimed in claim 1, wherein said at least one protective grid is formed of woven wires.

11. The protective grid system as claimed in claim 1, wherein said at least one protective grid is of composite plastic material and is configured by molding process.

12. The protective grid system as claimed in claim 1, wherein said at least one protective grid is received in at least one socket configured around said at least one outlet.

13. A protective grid system for ducts of a cooling module of a vehicle, said protective grid system comprising:
a housing comprising:
at least one inlet configured to be connected to the ducts for receiving air that extracts heat from a region to be cooled,
at least one outlet for egress of the air therethrough, and
a fan system for directing air from said at least one inlet to said at least one outlet,
the at least one inlet being disposed underneath the fan system and the at least one outlet being disposed downstream from the at least one inlet and the fan system and expels out the air from the cooling module; and
at least one protective grid adapted to be mounted over said at least one outlet to prevent articles of a predetermined size from entering inside said ducts of said cooling module while still permitting egress of air therethrough.
